(19) United States
(12) Patent Application Publication
(10) Pub. No.: US 2023/0138106 A1
(43) Pub. Date: May 4, 2023

(54) CONTAINERIZED BATTERY SYSTEM AND ANTI-CONDENSATION CONTROL SYSTEM FOR SAME

(71) Applicant: Caterpillar Inc., Peoria, IL (US)

(72) Inventor: Umakanth Sakaray, Dunlap, IL (US)

(73) Assignee: Caterpillar Inc., Peoria, IL (US)

(21) Appl. No.: 17/513,401

(22) Filed: Oct. 28, 2021

(51) Int. Cl. H01M 10/615; H01M 50/204; H01M 10/635; H01M 10/48; H01M 50/251; H01M 10/627

(52) U.S. Cl. CPC H01M 10/615; H01M 50/204; H01M 10/635; H01M 10/486; H01M 10/482; H01M 50/251; H01M 10/627; H01M 2220/10

(57) ABSTRACT

A containerized battery system includes a container having a container door, batteries within the container, and an electronically controlled container heater. The system further includes an anti-condensation control system including a access control unit structured to compare an inside dewpoint value to an outside dewpoint value, and operate the electronically controlled container heater to increase an inside temperature of the container to an anti-condensation target temperature. The access control unit is further structured to adjust the door access device to an unrestricted-access state based on the increase to the inside temperature of the container.

### TECHNICAL FIELD

The present disclosure relates generally to a containerized battery system, and more particularly to controlling access to a containerized battery system to limit condensation on batteries and related components.

### BACKGROUND

Containerized power modules are increasingly in use throughout the world. Providing power generation and power storage equipment in a containerized form offers many advantages respecting availability of electrical power for primary as well as backup power requirements at construction sites, industrial and data center facilities, and at a great many other locations such as mine or well sites, disaster zones, hospitals, et cetera.

In a typical containerized battery system electrical batteries are stored within a container such as an ISO (International Organization For Standardization) container. Many such containers can be readily transported on a truck, by rail, or on a marine vessel. In most applications, such containerized systems can be readily dispatched, redeployed, and serviced in the field.

Many modern electrical batteries, notably lithium-ion batteries, are optimally maintained in a relatively tight temperature range of 20° to 30° C. to extract better cycle performance and to minimize degradation of the batteries over time. For inspection and maintenance purposes, doors are typically installed on the containers where personnel may enter to service batteries or other equipment. In certain climates, particularly relatively hot and humid climates, when the service doors are opened humid air can enter the container with water condensing on the surface of the batteries and other electrical components given that the batteries are maintained at temperatures often colder than ambient. This can lead to performance degradation or failure of the system due to short circuits, and potentially cause other problems. One known power generation system is set forth in U.S. Pat. No. 7,221,061. In the '061 patent a containerized power generation system employs an engine having an external process module.

### SUMMARY

In one aspect, a containerized battery system includes a container having a container door, and batteries within the container, and an electronically controlled container heater. The system further includes an anti-condensation control system having inside sensors structured to monitor a temperature and a humidity inside the container, outside sensors structured to monitor a temperature and a humidity outside the container, a door access device adjustable among a plurality of states including an unrestricted-access state and a restricted-access state, and an access control unit. The access control unit is coupled with each of the electronically controlled container heater, the inside sensors, the outside sensors, and the door access device. The access control unit is structured to determine an inside dewpoint value based on the monitored temperature and humidity inside the container, and to determine an outside dewpoint value based on the monitored temperature and humidity outside the container. The access control unit is further structured to operate the electronically controlled heater to increase an inside temperature of a container to an anti-condensation target temperature based on a difference between the inside dewpoint value and the outside dewpoint value. The containerized battery system is further structured to adjust the door access device to the unrestricted-access state based on the increase to the inside temperature of the container.

In another aspect, a method of operating a containerized battery system includes receiving a user access request to open a door to a container having batteries therein, and determining an inside dewpoint value of the container and determining an outside dewpoint value, responsive to the user access request. The method further includes comparing the inside dewpoint value to the outside dewpoint value, and increasing an inside temperature of the container from a working temperature to an anti-condensation target temperature based on a difference between the inside dewpoint value and the outside dewpoint value. The method still further includes enabling access to the container via the door based on the increase in the inside temperature to the anti-condensation target temperature.

In still another aspect, an anti-condensation control system for a containerized battery system includes a door access device adjustable among a plurality of states including an unrestricted-access state and a restricted-access state. The control system further includes an access control unit coupled with the door access device and structured to receive a user access request produced by the door access device, receive data indicative of an inside dewpoint temperature of a container, and receive data indicative of an outside dewpoint temperature. The access control unit is further structured to compare the inside dewpoint temperature to the outside dewpoint temperature, and adjust the door access device from the unrestricted-access state to the restricted-access state based on the user access request. The access control unit is still further structured to output a heater control signal to an electronically controlled container heater to increase an inside temperature of the container from a working temperature to an anti-condensation target temperature that is greater than the outside dewpoint temperature. The access control unit is still further structured to adjust the door access device from the restricted-access state to the unrestricted-access state based on the increase to the inside temperature of the container.

### BRIEF DESCRIPTION OF THE DRAWINGS

FIG. 1 is a diagrammatic view of a containerized battery system, according to one embodiment;

FIG. 2 is a schematic view of a containerized battery system, according to one embodiment; and

FIG. 3 is a flowchart illustrating example methodology and logic flow, according to one embodiment.

### DETAILED DESCRIPTION

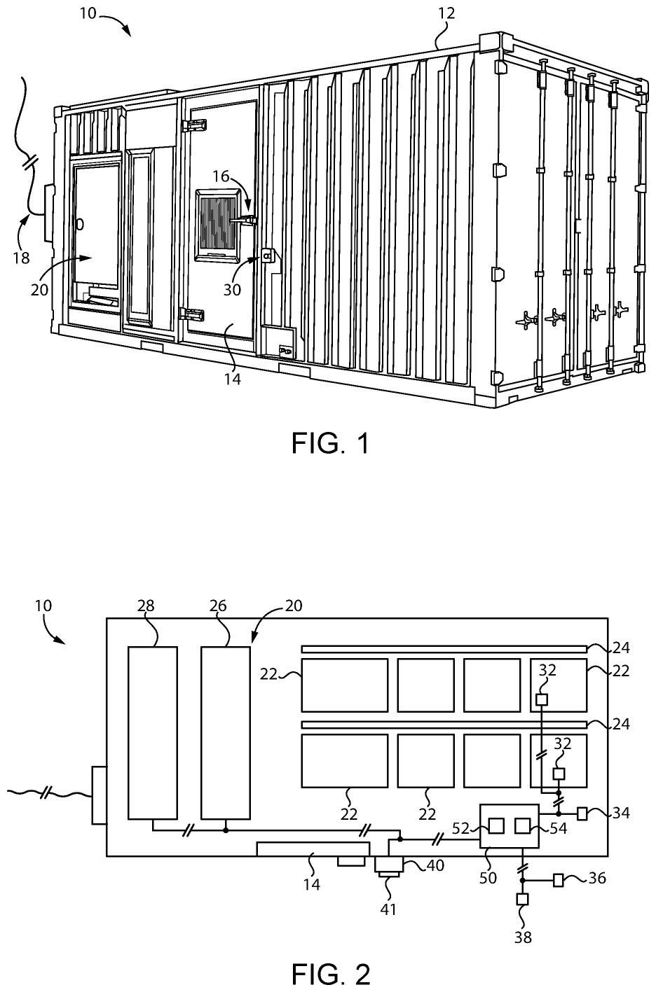

Referring to FIG. 1, there is shown a containerized battery system 10, according to one embodiment. Battery system 10 includes a container 12 having at least one container door 14 that provides access for personnel inside container 12. Container 12 is also equipped with a latching/locking mechanism 16 that can include a known handle and manually or electronically operable lock (not shown) to secure container door 14. Battery system 10 is also equipped with a shore power connection 18 enabling apparatus inside container 12 to be electrically connected to a local electrical grid, to any electrical grid, or directly to a load, to receive electrical power for charging batteries within container 12, or to discharge batteries within container 12 to provide electrical power, as the case may be. Apparatus inside container 12 can be electrically powered via shore power when battery system 10 is serviced. Container 12 can include a known container configuration, for example, having any of a range of ISO footprints enabling container 12 and battery system 10 to be transported by truck, rail, or marine vessel, and handled with a variety of types of standard ISO container handling equipment. Battery system 10 can be situated at a construction site, a data center or server farm, at a wellhead, a mine, at an industrial location, as well as at virtually every other conceivable location including disaster sites. As explained above, containerized battery systems can be deployed at relatively hot and humid locations. Batteries to be described in battery system 10 are often operated in a working temperature range that is, at least at times, cooler than an ambient temperature. Depending upon dewpoint levels inside container 12, and outside container 12 when container door 14 is opened batteries inside container 12 can be exposed to air having a dewpoint greater than a battery module or battery pack temperature or another temperature inside container 12, resulting in condensation depositing upon the equipment. As will be further apparent from the following description, battery system 10 is equipped with control system and logic functions that enable increasing an inside temperature of container 12 above an outside dewpoint temperature to limit or eliminate any condensation that might otherwise occur.

Referring also now to FIG. 2, battery system 10 further includes batteries 22 within container 12, such as lithium-ion batteries, supported on or by battery racks 24. Battery system 10 also includes an HVAC system 20 having an electronically controlled container heater 26 and an electronically controlled container cooler 28. Battery system 10 further includes an anti-condensation control system 30. Control system 30 may include inside sensors structured to monitor a temperature and humidity inside container 12, including for instance one or more inside temperature sensors 32 and an inside humidity sensor 34. The one or more inside temperature sensors 32 may include battery module or battery pack temperature sensors in contact with or in proximity to one or more of batteries 22. Inside temperature sensors 32, hereinafter referred to at times in the singular, together with inside humidity sensor 34, may be structured to produce temperature data and humidity data indicative of an inside dewpoint value of container 12. The inside dewpoint value may include an inside dewpoint temperature, but could include a temperature range or zone, or some other numerical value. The outside sensors may include an outside temperature sensor 36 and an outside humidity sensor 38 structured to monitor a temperature and a humidity outside container 12, namely, an ambient temperature and an ambient humidity, and together structured to produce temperature data and humidity data indicative of an outside dewpoint value such as an outside dewpoint temperature. In other instances, outside temperature data and outside humidity data, or an outside dewpoint value, could be obtained by way of apparatus separate from battery system 10 itself, such as temperature and/or humidity sensors located amongst a plurality of battery systems and indicating the desired information at a location more generally. Combined temperature and humidity sensors are well known and commercially available.

Control system 30 may further include a door access device 40 adjustable among a plurality of states including an unrestricted-access state and a restricted-access state. The door access device can include a device that prevents physical opening of container door 14, such as an electronically controlled lock. In a practical implementation, door access device 40 may perform an access control function without physically locking or unlocking container door 14. In one embodiment, door access device 40 includes an illuminable indicator and the unrestricted-access state and the restricted-access state include a first illumination state meaning access is allowed and a second illumination state meaning access is not allowed, respectively. For instance, door access device 40 may include a light 41 that is turned on, turned off, varied in intensity or color of illumination, or varied amongst a flashing mode, a non-flashing mode, or still others, as further described herein.

Control system 30 further includes an access control unit 50. Access control unit 50 may be in control communication with container heater 26 and container cooler 28 to send control signals to either and structured to receive a user access request produced by door access device 40. Access control unit 50 may also be structured to receive temperature data and humidity data (a temperature signal, a humidity signal, or a dewpoint temperature signal, for instance) indicative of an inside dewpoint value, such as a dewpoint temperature, of container 12, and to receive temperature data and humidity data indicative of an outside dewpoint value, such as a dewpoint temperature. Access control unit 50 may also be structured to determine an inside dewpoint value based on the monitored temperature and humidity inside container 12, and to determine an outside dewpoint value based on the monitored temperature and humidity outside container 12.

Access control unit 50 may also be structured to compare the inside dewpoint temperature or temperature value to the outside dewpoint temperature or temperature value based on the user access request received. In an implementation, access control unit 50 is structured to adjust door access device 40 from the unrestricted-access state to the restricted-access state based on a difference between the inside dewpoint temperature value or temperature and the outside dewpoint temperature or value. Access control unit 50 may also be structured to output a heater control signal to electronically controlled heater 26, to increase an inside temperature of container 12 from a working temperature to an anti-condensation target temperature. The anti-condensation target temperature may be greater than the outside dewpoint temperature. Based on the increase to the inside temperature of container 12 access control unit 50 can adjust door access device 40 from the restricted-access state to the unrestricted-access state. This functionality can generally be understood as access control unit 50 varying the state of door access device 40 when a difference between the outside dewpoint temperature and the inside dewpoint temperature is determined, namely, where the inside dewpoint temperature is lower than, or sufficiently lower than, the outside dewpoint temperature, to indicate that a risk of condensation exists. If such risk exists, electronically controlled heater 26 can be operated to increase inside temperature of container 12 to a level sufficient to mitigate the risk of condensation. The anti-condensation target temperature to which the inside temperature of container 12 is increased may be not only greater than the outside dewpoint temperature but also less than or equal to a battery safe temperature. In other words, there may be an upper threshold in temperature above which it is undesirable to heat the inside of container 12. Access control unit 50 can include a data processor 52, such as a microprocessor, a microcontroller, or any other suitable programmable logic controller, and a computer readable memory 54. Computer readable memory 54 can include any suitable memory type such as RAM, ROM, DRAM, SDRAM, EEPROM, FLASH, or still another, and stores program control instructions executed by processor 52 to limit condensation upon batteries 22, racks 24, or other equipment inside container 12.

As noted above, door access device 40 can include an illuminable indicator 41, such as an LED light or the like. Indicator 41 may be an illuminable push-button in some instances functioning as a user access switch structured to produce the user access request. The user access switch and illuminable indicator 41 may be integrated, such that the illuminable indicator 41 is resident on the user access switch.

Moreover, once servicing of battery system 10 is complete control system 30 can operate electronically controlled container cooler 28 to decrease the inside temperature of container 12 to a working temperature less than an outside dewpoint temperature, thus after the operating of electronically controlled heater 26 to increase the inside temperature to the anti-condensation target temperature. In an embodiment, access control unit 50 way receive an access completed signal, such as from door access device 40 or another device indicating container door 40 has been closed, for example, and that personnel have exited after completing servicing, and conditions are appropriate for returning container 12 to a standard working temperature. During servicing battery system 10 power can be provided by way of shore power connection 18.

### INDUSTRIAL APPLICABILITY

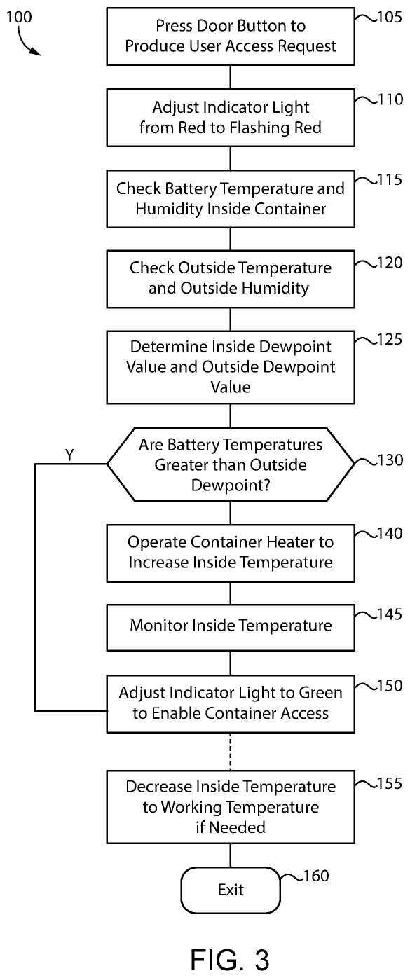

With continued reference to the drawings, but also now to FIG. 3, there is shown a flowchart 100 illustrating example process and logic flow, according to one embodiment. At a block 105, a door button (door access device 40) is pressed to produce the user access request. Pressing the door button can be understood as a request by personnel to access container 12 by opening door 14. Responsive to the user access request, at a block 110 an indicator light 41, such as a light of door access device 40, may be adjusted from a first illumination state to a second illumination state. In the illustrated block 110 the indicator light is adjusted from red to flashing red. From block 110 flowchart 100 advances to a block 115 to check battery temperature and humidity inside container 12. Block 115 can be understood as determining an inside dewpoint value of container 12, for instance via map lookup. From block 115, or potentially in parallel with block 115, flowchart 100 advances to a block 120 to check outside temperature and outside humidity, thus determining an outside dewpoint value, again using a map lookup, for example. From block 120 flowchart 100 advances to a block 125 to determine the inside dewpoint value and outside dewpoint value.

From block 125 flowchart 100 advances to a block 130 to query are battery temperatures greater than outside dewpoint? Determining whether battery temperatures are greater than the outside dewpoint can include performing an arithmetic comparison and calculating a difference between the respective temperatures, for instance. If yes, flowchart 100 can advance to a block 150 to adjust the indicator light to green to enable container access.

If, at block 130, battery temperatures are not greater than the outside dewpoint, flowchart 100 can advance to a block 140 to operate container heater 26 to increase the inside temperature of container 12 by initiating operating container heater 26 as described herein. From block 140, flowchart 100 can advance to a block 145 to monitor the inside temperature of container 12 as heater 26 operates. At block 145 access control unit 50 can be monitoring inside temperature in a closed-loop fashion to determine when the anti-condensation target temperature is reached. At a block 150 the indicator light is adjusted to green to enable container access as discussed herein. At a block 155 inside temperature of container 12 is decreased to the working temperature, if needed. At a block 160 the logic exits.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A containerized battery system comprising:
a container including a container door;
batteries within the container;
an electronically controlled container heater;
an anti-condensation control system including inside sensors structured to monitor a temperature and a humidity inside the container, outside sensors structured to monitor a temperature and a humidity outside the container, a door access device adjustable among a plurality of states including an unrestricted-access state and a restricted-access state, and an access control unit;
the access control unit is coupled with each of the electronically controlled container heater, the inside sensors, the outside sensors, and the door access device, and structured to:
determine an inside dewpoint value based on the monitored temperature and humidity inside the container;
determine an outside dewpoint value based on the monitored temperature and humidity outside the container;
operate the electronically controlled heater to increase an inside temperature of the container to an anti-condensation target temperature based on a difference between the inside dewpoint value and the outside dewpoint value; and
adjust the door access device to the unrestricted-access state based on the increase to the inside temperature of the container.

2. The system of claim 1 wherein the access control unit is further structured to adjust the door access device to the restricted-access state and to initiate the operating of the electronically controlled heater, based on a user access request.

3. The system of claim 2 wherein the door access device includes an illuminable indicator and the unrestricted-access state and the restricted-access state include a first illumination state and a second illumination state, respectively.

4. The system of claim 3 further comprising a user access switch structured to produce the user access request, and the illuminable indicator is resident on the user access switch.

5. The system of claim 1 wherein the inside sensors include a battery temperature sensor structured to produce a temperature signal indicative of a battery module or battery pack temperature of at least one of the batteries.

6. The system of claim 5 wherein the inside dewpoint value includes an inside dewpoint temperature, and the access control unit is further structured to determine the difference in temperature by comparing the temperature indicated by the temperature signal to the inside dewpoint temperature.

7. The system of claim 6 wherein the target temperature is a temperature greater than the outside dewpoint temperature and less than a battery safe temperature.

8. The system of claim 1 further comprising an electronically controlled container cooler, and the access control unit is further structured to operate the electronically controlled container cooler to decrease the inside temperature to a working temperature less than an outside dewpoint temperature after the operating of the electronically controlled heater to increase the inside temperature.

9. A method of operating a containerized battery system comprising:
receiving a user access request to open a door to a container having batteries therein;
determining an inside dewpoint value of the container and determining an outside dewpoint value, responsive to the user access request;
comparing the inside dewpoint value to the outside dewpoint value;
increasing an inside temperature of the container from a working temperature to an anti-condensation target temperature based on a difference between the inside dewpoint value and the outside dewpoint value; and
enabling access to the container via the door based on the increase in the inside temperature to the anti-condensation target temperature.

10. The method of claim 9 wherein the enabling access to the container further includes adjusting a door access device from a restricted-access state to an unrestricted-access state.

11. The method of claim 10 wherein the restricted-access state includes an illumination state.

12. The method of claim 10 wherein the receiving of the user access request includes receiving the user access request inputted by way of a switch of the door access device.

13. The method of claim 9 wherein:
the determining an inside dewpoint value and an outside dewpoint value includes determining an inside dewpoint temperature and an outside dewpoint temperature; and
the anti-condensation target temperature includes an inside temperature greater than the inside dewpoint temperature.

14. The method of claim 9 further comprising reducing an inside temperature from the target anti-condensation temperature to a working temperature after the increasing of the inside temperature.

15. The method of claim 9 further comprising monitoring the inside temperature, and wherein the enabling access to the container is based on the monitored inside temperature.

16. The method of claim 9 further comprising monitoring a battery temperature, and determining the inside dewpoint value based on the monitored battery temperature.

17. An anti-condensation control system for a containerized battery system comprising:
a door access device adjustable among a plurality of states including an unrestricted-access state and a restricted-access state;
an access control unit coupled with the door access device and structured to:
receive a user access request produced by the door access device;
receive data indicative of an inside dewpoint temperature of a container;
receive data indicative of an outside dewpoint temperature;
compare the inside dewpoint temperature to the outside dewpoint temperature;
adjust the door access device from the unrestricted-access state to the restricted-access state based on the user access request;
output a heater control signal to an electronically controlled container heater to increase an inside temperature of the container from a working temperature to an anti-condensation target temperature that is greater than the outside dewpoint temperature; and
adjust the door access device from the restricted-access state to the unrestricted-access state based on the increase to the inside temperature of the container.

18. The system of claim 17 wherein the door access device includes a switch and an illuminable indicator adjustable between the restricted-access state and the unrestricted-access state.

19. The system of claim 18 wherein the restricted-access state includes a first color illumination state and the unrestricted-access state includes a second color illumination state.

20. The system of claim 17 wherein the access control unit is further structured to receive an access completed signal, and to output a control signal to an electronically controlled container cooler to reduce an inside temperature from the target anti-condensation temperature to a working temperature based on the access completed signal.
